(19) United States
(12) Patent Application Publication
(10) Pub. No.: US 2009/0049491 A1
(43) Pub. Date: Feb. 19, 2009

(54) Resolution Video File Retrieval

(75) Inventors: Olli Johannes Karonen, Helsinki (FI); Pekka Ilmari Lahtinen, Helsinki (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 11/839,820

(22) Filed: Aug. 16, 2007

(51) Int. Cl. H04N 7/173

(52) U.S. Cl. 725/105

(57) ABSTRACT

Peer-to-peer and IPTV based technologies have facilitated tremendous growth in terms of the sharing of video files in computer networks and on the Internet. This growth has imposed an immense challenge on service providers in terms of being able to handle continuously increasing loads while still ensuring (a minimum) quality of service. This invention responds to the noted challenge by providing a novel apparatus, method and system for providing video to an end user at various resolutions. Additional benefits include the preservation of computing resources in terms of processing resources, power, and bandwidth while still providing users with content-rich services.

### FIELD OF THE INVENTION

Aspects of the invention generally relate to peer-to-peer computing technologies. More specifically, an apparatus, method and system for providing video to an end user at various resolutions are provided.

### BACKGROUND OF THE INVENTION

Improvements in computing technologies have changed the way people interact with one another, as well as how people share information with one another. Such improvements include the introduction of peer-to-peer based file sharing protocols, such as the BitTorrent communications protocol. Prior to the emergence of peer-to-peer based technologies in computer networks, the conventional methods of distributing information (often in the form of computer files and the like) was based on a more conventional client-server relationship. Peer-to-peer technology improved overall system reliability by allowing one or more peer computers to serve as a source of information requested by another peer computer. Thus, the risk of not being able to obtain information due to a server being non-operational (either due to the server itself, or one or more network connections) is mitigated because the risk itself is distributed amongst the peer computing devices. Moreover, the peer computers can be configured to share the load with respect to information distribution within the network, thereby not overburdening any single computer.

The file sharing experience has been further enriched as a result of the establishment of Internet Protocol Television (IPTV). IPTV is a system wherein a digital television service is delivered by using Internet Protocol over a network infrastructure, which may include delivery by a broadband connection. Instead of being delivered through traditional broadcast and cable formats, IPTV television content is received by the viewer via technologies typically used for computer networks. IPTV offers numerous advantages over traditional architectures, such as allowing the integration of television with other IP-based services like high speed Internet access and Voice over Internet Protocol (VoIP). Moreover, switched IP networks allow bandwidth to be conserved. More specifically, in a conventional network using broadcast video technology, all the content available flows downstream to each viewing station, and a user switches the content at a set-top box or the like. Conversely, in a switched IP network, all the available content remains in the network, and only the content that an individual user selects is sent to the user's device. Thus, the quality of service (e.g., the quality of a picture) may be enhanced without incurring the expense of having to allocate additional resources at each viewing station.

Peer-to-peer and IPTV based technologies have facilitated tremendous growth in terms of the sharing of video files in computer networks and on the Internet. This growth has imposed an immense challenge on service providers in terms of being able to handle continuously increasing loads while still ensuring (a minimum) quality of service. Video files tend to consume large amounts of bandwidth when transferred from one computing device to another. Some estimates have indicated that video downloading accounts for fifty percent of all Internet traffic. Irrespective of the actual share of Internet traffic, it suffices to say that there is a genuine need in the art to implement as many measures as possible in order to preserve bandwidth, particularly as the popularity, and hence growth, of video file sharing continues to increase. Moreover, it would be advantageous if such measures would take into consideration the computing platforms involved in the video distribution.

### BRIEF SUMMARY OF THE INVENTION

The following presents a simplified summary of aspects of the invention in order to provide a basic understanding of some aspects of the invention. This summary is not an extensive overview, and is not intended to identify key or critical elements or to delineate the scope of the claims. The following summary merely presents some concepts and aspects of the invention in a simplified form as a prelude to the more detailed description provided below.

To overcome limitations in the prior art described above, and to overcome other limitations that will be apparent upon reading and understanding the present specification, aspects of the present invention are directed to a novel apparatus, method and system for providing quick access to a video file at a first resolution, with subsequent access to a more permanent version of the video file at a second, e.g., higher, resolution.

A first aspect provides a video file from a first source device live at a first resolution to a first destination device.

A second aspect provides the video file from the first source device at a second resolution.

A third aspect provides the video file from a second source device at the second resolution.

A fourth aspect provides the video to the second source device from the first source device.

A fifth aspect encodes video in a plurality of resolutions.

A sixth aspect embeds identifying information in the form of metadata into transmitted video during a first distribution.

A seventh aspect embeds identifying information into a distribution protocol during the first distribution.

An eighth aspect indicates a video file has already been accessed or received.

These and other aspects of the invention generally relate to a source device shooting and distributing video footage live at a first (e.g., lower) resolution, while simultaneously saving the video footage at a second (e.g., higher) resolution. Identifying information may be included with the distribution to enable a receiving device to determine the source and/or nature of the video being received. A receiving device may subsequently generate a request for redistribution based on the identifying information, wherein the receiving device sends the request to the source device. The source device may redistribute the saved video at the second resolution responsive to the request. The initial distribution and/or redistribution may take place via one or more protocols (e.g., BitTorrent), wherein the protocols may support live and/or “almost live” (e.g., slightly delayed) distribution. The source device may also upload the saved video to one or more servers, thereby enabling the video to be retrieved from the one or more servers. One or more URLs associated with the one or more servers may also be sent from the source device to the receiving device to provide an indication of the server(s) where the video file may be obtained from.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a network computing environment suitable for carrying out one or more illustrative aspects of the invention.

FIG. 2 illustrates a data processing architecture suitable for carrying out one or more illustrative aspects of the invention.

FIG. 3 illustrates in block diagram form a device suitable for shooting and transmitting video in accordance with one or more illustrative aspects of the invention.

FIG. 4 illustrates data flow for accessing and receiving video in accordance with one or more illustrative aspects of the invention.

FIG. 5 illustrates a method suitable for uploading video to a server in accordance with one or more illustrative aspects of the invention.

### DETAILED DESCRIPTION

In the following description of the various embodiments, reference is made to the accompanying drawings, which form a part hereof, and in which is shown by way of illustration various embodiments in which one or more aspects of the invention may be practiced. It is to be understood that other embodiments may be utilized and structural and functional modifications may be made without departing from the scope of the present invention.

Conventional processes for producing video in two resolutions include the steps of: (1) while shooting live video, encoding the video in high resolution via video capture hardware, software, and/or firmware, (2) decoding the video to yield an unpacked “full image” version of the video in high resolution, (3) downscaling the full image to the low resolution, and (4) re-encoding the low resolution full image to another video stream or file. These processes, however, typically consume too much time to be carried out while also distributing the video concurrently. Thus, as demonstrated herein, one or more aspects of the invention provide for the simultaneous encoding of video into two (or more) resolutions, saving both time and processing resources.

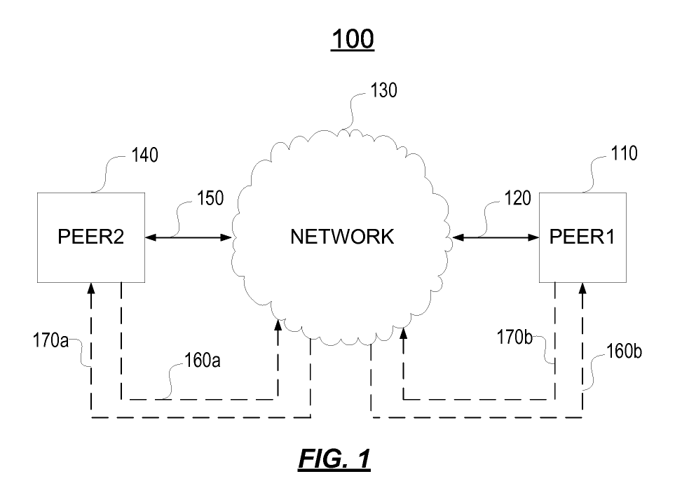

FIG. 1 illustrates a network computing environment 100 suitable for carrying out one or more aspects of the present invention. For example, FIG. 1 illustrates a first peer device PEER1 110 connected to a network 130 via a connection 120. Network 130 may include the Internet, an intranet, wired or wireless networks, or any other mechanism suitable for facilitating communication between computing platforms in general. FIG. 1 also depicts a second peer device PEER2 140 connected to network 130 via a connection 150. By virtue of the connectivity as shown, PEER1 110 and PEER2 140 may communicate with one another. Such communications may enable the exchange of various types of information. For example, the communications may include data to be exchanged between PEER1 110 and PEER2 140. Such data may include video files and the like. The communications may further include additional information such as control information.

Connections 120 and 150 illustrate interconnections for communication purposes. The actual connections represented by connections 120 and 150 may be embodied in various forms. For example, connections 120 and 150 may be hardwired/wireline connections. Alternatively, connections 120 and 150 may be wireless connections. Connections 120 and 150 are shown in FIG. 1 as supporting bi-directional communications (via the dual arrow heads on each of connections 120 and 150). Alternatively, or additionally, computing environment 100 may be structured to support separate forward (160a and 160b) and reverse (170a and 170b) channel connections to facilitate the communication.

Computing environment 100 may be carried out as part of a larger network consisting of more than two peer devices. For example, PEER2 140 may exchange communications with a plurality of other peer devices (not shown) in addition to PEER1 110. The communications may be conducted using one or more communication protocols. Furthermore, computing environment 100 may include one or more intermediary nodes (not shown) that may buffer, store, or route communications between the various peer devices.

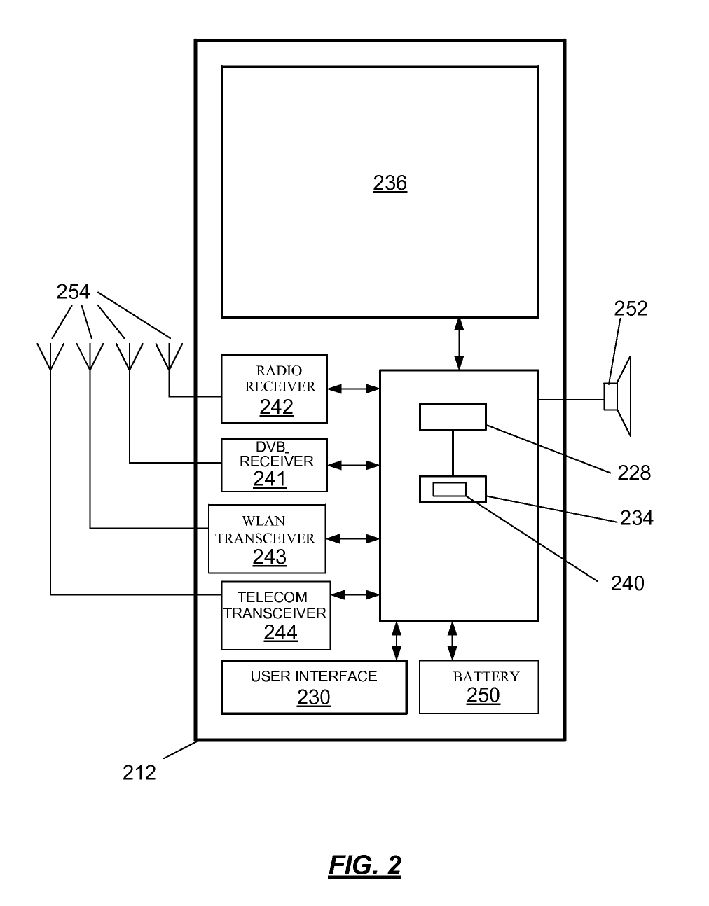

FIG. 2 illustrates a generic computing device 212, e.g., a desktop computer, laptop computer, notebook computer, network server, portable computing device, personal digital assistant, smart phone, mobile telephone, cellular telephone (cell phone), terminal, distributed computing network device, or any other device having the requisite components or abilities to operate as described herein. As shown in FIG. 2, device 212 may include processor 228 connected to user interface 230, memory 234 and/or other storage, and display 236. Device 212 may also include battery 250, speaker 252 and antennas 254. User interface 230 may further include a keypad, touch screen, voice interface, four arrow keys, joy-stick, stylus, data glove, mouse, roller ball, touch screen, or the like. In addition, user interface 230 may include the entirety of or portion of display 236. Computer executable instructions and data used by processor 228 and other components within device 212 may be stored in a computer readable memory 234. The memory may be implemented with any combination of read only memory modules or random access memory modules, optionally including both volatile and nonvolatile memory. Software 240 may be stored within memory 234 and/or storage to provide instructions to processor 228 for enabling device 212 to perform various functions. Alternatively, some or all of the computer executable instructions may be embodied in hardware or firmware (not shown). Furthermore, the computing device 212 may include additional hardware, software and/or firmware to support one or more aspects of the invention as described herein. For example, computing device 212 may include a camera (not shown) and/or audiovisual (e.g., movie/film) support software/firmware. Device 212 may be configured to receive, decode and process digital broadband broadcast transmissions that are based, for example, on the Digital Video Broadcast (DVB) standard, such as DVB-H, DVB-T or DVB-MHP, through a specific DVB receiver 241. The mobile device may also be provided with other types of receivers for digital broadband broadcast transmissions. Additionally, device 212 may also be configured to receive, decode and process transmissions through FM/AM Radio receiver 242, WLAN transceiver 243, and telecommunications transceiver 244. In at least one embodiment of the invention, device 212 may receive radio data stream (RDS) messages.

Computer program product implementations may include a series of computer instructions fixed either on a tangible medium, such as a computer readable medium (e.g., a diskette, CD-ROM, ROM, DVD, fixed disk, etc.) or transmittable to computer device 212, via a modem or other interface device, such as a communications adapter connected to a network over a medium, which is either tangible (e.g., optical or analog communication lines) or implemented wirelessly (e.g., microwave, infrared, or other transmission techniques). The series of computer instructions may embody all or part of the functionality with respect to the computer system, and can be written in a number of programming languages for use with many different computer architectures and/or operating systems, as would be readily appreciated by one of ordinary skill. The computer instructions may be stored in any memory device (e.g., memory 234), such as a semiconductor, magnetic, optical, or other memory device, and may be transmitted using any communications technology, such as optical infrared, microwave, or other transmission technology. Such a computer program product may be distributed as a removable medium with accompanying printed or electronic documentation (e.g., shrink wrapped software), preloaded with a computer system (e.g., on system ROM or fixed disk), or distributed from a server or electronic bulletin board over a network (e.g., the Internet or World Wide Web). Various embodiments of the invention may also be implemented as hardware, firmware or any combination of software (e.g., a computer program product), hardware and firmware. Moreover, the functionality as depicted may be located on a single physical computing entity, or may be divided between multiple computing entities.

For purposes of facilitating the following description, examples will be provided herein as they relate to the interaction of various types of computing platforms or devices, such as cell phones, handheld devices, personal computers (PCs), servers and the like. These platforms/devices are merely illustrative, and one of skill in the art will appreciate that they may readily be combined or interchanged with other types of computing platforms/devices without departing from the scope of the present invention.

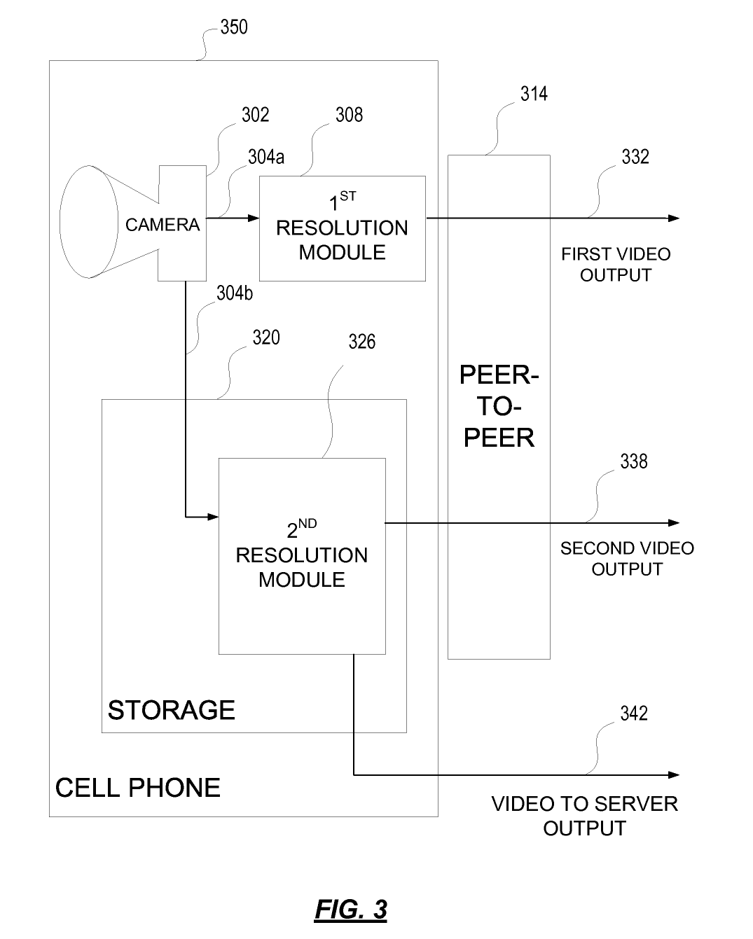

FIG. 3 illustrates in block diagram form an architecture suitable for carrying out one or more aspects of the invention as described herein. FIG. 3 illustrates a cell phone 350 that includes a camera 302. Camera 302 may be configured to shoot and record footage of various subjects. Camera 302 may produce one or more audiovisual outputs characterizing the subject matter that has been shot. The one or more audiovisual outputs may be routed via one or more lanes or channels. For example, camera 302 may be configured to produce an audiovisual output on a single channel, or camera 302 may be configured to produce the audio component on a first channel and the visual component on a second channel. Cell phone 350 serves as an example of a source device that can be used for the recording and/or distribution of video content and the like. As discussed below, a source device may be any device (e.g., servers, computers, etc.) that facilitate the distribution of content.

Cell phone 350 may also include a first resolution module 308. First resolution module 308 may include software and/or hardware for facilitating distribution of live streaming video at a first resolution. First resolution module 308 may receive as input video output 304a from camera 302. First video output 332 (e.g., live streaming video) of first resolution module 308 may be acquired by a peer device (not shown in FIG. 3) via a peer-to-peer environment 314. Furthermore, first resolution module 308 may facilitate the inclusion of identifying information in the form of metadata embedded in the transmitted video itself. The identifying information may be included to identify either the source of the video (e.g., cell phone 350, or the user of cell phone 350) or the video itself. The identifying information may include an author identity, source device address, file identity, date and time stamps and the like. The author identity may include a person's name, a login or username, a telephone number, a combination thereof, or the like. The source device address may be some combination of a manufacturer identification number and a serial number or the like. The file identity may be a sequentially generated number, or it may take the form of a mnemonic title to help a user remember the subject matter of the video file. All of the different types of identifying information that may be included may be generated on an automated basis (e.g., based on default settings or settings previously input by a user). Alternatively, the identifying information may be generated manually (e.g., via user interaction based on a menu driven approach). Additionally, the identifying information may be generated via a combination of automation and manual entry. Instead of the identification information being contained in the video itself, the identification information may be included separately as a part of the distribution protocol.

Cell phone 350 may include storage 320 (e.g., memory 234) for purposes of saving the video footage. For example, the video footage may be saved as a video file or in another suitable format. Moreover, storage 320 may further include a second resolution module 326 to further facilitate saving the recorded video. Second resolution module 326 may receive as input video output 304b from camera 302. Generally, second resolution module 326 may be configured to produce a second video output 338 of different resolution than first video output 332. For example, second resolution module 326 may be configured to produce second video output 338 at a higher resolution than first video output 332. Alternatively, second resolution module 326 may be configured to produce second video output 338 at a lower resolution than first video output 332. Moreover, first resolution module 308 and second resolution module 326 may be configured to produce outputs (332 and 338) of the same resolution. Furthermore, the output (332 and 338) resolution produced by each of first resolution module 308 and second resolution module 326 may be variable. Second video output 338 may be accessed for later retrieval (e.g., after the live transmission associated with first video output 332) via peer-to-peer environment 314. Second resolution module 326 may include an additional output (video to server output 342) to facilitate uploading video to a server or the like as will be discussed in greater detail below, thereby providing an additional mechanism in which the video can be acquired after the live transmission associated with first video output 332 has finished.

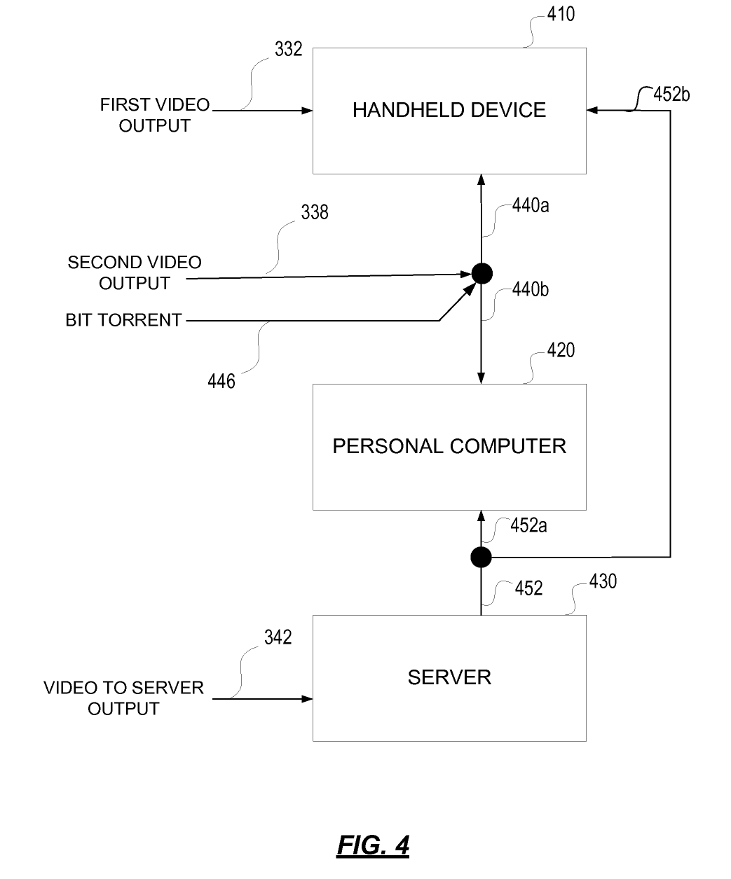

FIG. 4 illustrates in block diagram form various entities configured to receive the outputs generated by the architecture depicted in FIG. 3. For example, if the intended target of first video output 332 is a handheld device 410 characterized by a low quality video display, then first resolution module 308 may be configured to generate a low resolution first video output 332, because handheld device 410 might not be able to make use of high resolution video anyway. Thus, savings in terms of bandwidth, processing power, and battery life may be obtained by reducing the bitrate as low as possible while still maintaining some (minimum) level of quality with respect to the video to be displayed on handheld device 410. If cell phone 350 initiated the transmission to handheld device 410, then cell phone 350 (or a user of cell phone 350) may know in advance the display capabilities of handheld device 410. For example, cell phone 350 may keep a log of all devices it has communicated with in the past along with each device's display capabilities. Alternatively, cell phone 350 may request the handheld device 410 to provide cell phone 350 with some measure of the display capabilities supported by handheld device 410 prior to shooting or transmitting video to handheld device 410. This latter technique of providing the handheld device's display capabilities may also be included automatically if handheld device 410 initiated the video transmission request. Alternatively, the first video resolution may be some predefined resolution lower than the second video resolution.

As illustrated in FIG. 4, handheld device 410 (or the user of handheld device 410) may decide that after having viewed/accessed the selected video live at a first resolution that the video was of interest, and thus would like to view/access the video again. Handheld device 410 may store identifying information regarding the video, and/or may display the identifying information while playing the video, such as via a momentary text banner or the like, thus reinforcing the source and nature of the video being presented. Handheld device 410 may use the identifying information included in the first video output 332 to formulate a request for retransmission of the video. Responsive to the request, handheld device 410 may receive a retransmission 440a via peer-to-peer environment 314 directly by way of the second video output 338. Alternatively, handheld device 410 may receive a retransmission 440a via a BitTorrent file 446 or other transmission protocol wherein one or more other peer devices contribute a portion of (or even the entire) retransmission 440a. Handheld device 410 may obtain BitTorrent file 446 via a torrent file URL transmitted by cell phone 350 that may contain at least some of the identifying information discussed previously.

Handheld device 410 may maintain a listing of all videos that it has received in its history. Alternatively, handheld device 410 may maintain a listing of the last N (e.g., 100) videos it has received, or may apply some other criteria such as date or time to determine how many of the past videos to maintain a record of in the listing. The listing may be based on the identifying information received in conjunction with first video output 332. A user of handheld device 410 may later wish to save or view the video on another device, such as personal computer 420. A user may connect handheld device 410 to personal computer 420 via a cradle or some other wired or wireless connection, at which point personal computer 420 may synchronize a local copy of the listing of videos to that contained on the handheld device 410. The synchronization may occur in the opposite direction, so that a listing of videos viewed on personal computer 420 may instead be sent to the handheld device 410. Alternatively, the synchronization may be based on time stamps so as to bring the listings on both the personal computer 420 and handheld device 410 to the same status irrespective of on which platform a video was first viewed. Additional options may be included to enable a user to determine which videos to synchronize in the respective listings. Further, the listings might not be synchronized at all, and a user may simply use the listing on a first device (e.g., handheld device 410) as a reference by which to (manually) access the video on a second device (e.g., personal computer 420). For example, assuming that a video was first received/viewed on handheld device 410, a user may subsequently wish to view the video on personal computer 420. Thus, the user may use the identifying information included in first video output 332 to obtain a retransmission 440b of the video. Retransmission 440b may be generated directly from second video output 338 of second resolution module 326. Alternatively, or additionally, retransmission 440b may be generated via a BitTorrent file 446 or other transmission protocol wherein one or more peer devices contribute a portion of (or even the entire) retransmission 440b. Personal computer 420 may obtain BitTorrent file 446 via a torrent file URL transmitted by cell phone 350 that may contain at least some of the identifying information discussed previously.

The torrent file URL may be transmitted by cell phone 350 prior to the start of the live distribution of video content received via first video output 332. Alternatively, the torrent file URL (as well as the identifying information, and any other information or URL(s) that may provide further information or access to the video) may periodically be transmitted during the live distribution. Periodically transmitting the torrent file URL during the live distribution provides additional benefits which include: (1) enabling receiving/destination devices that were not initially present at the beginning of the live distribution to attain the torrent file URL, and (2) enabling receiving/destination devices to terminate reception prior to the conclusion of the live distribution, yet still having an ability to access one or more torrent files after the live distribution has concluded. Furthermore, cell phone 350 may transmit the torrent file URL at the end of the live distribution; this may be particularly true in an embodiment where the user of cell phone 350 (e.g., the source of the video) provides identifying information at the conclusion of the video shoot. For example, a user of cell phone 350 may desire to direct an audience's attention to one or more precursory videos (e.g., advertisements) prior to providing access (via the identifying information) to a primary video of interest. Thus, the user of cell phone 350 may purposely withhold the identifying information until the precursory videos have been received and/or viewed. The torrent files may be retrieved via a cellular data call based on a telephone number of the source device; this may be particularly advantageous when the source device cannot be contacted via the Internet, but the video itself is accessible on other BitTorrent hosts (e.g., other peer devices). The torrent files may be updated periodically as new material is shot; when the shooting of the video is completed, the torrent files may be finalized.

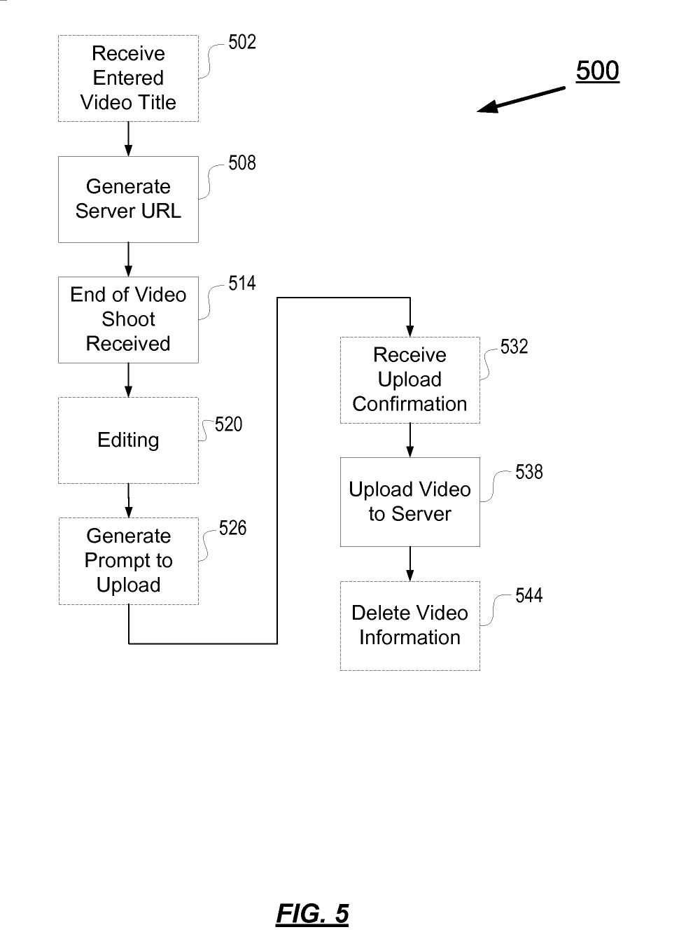

FIG. 5 illustrates a method 500 suitable for execution on cell phone 350 to facilitate uploading video from cell phone 350 to server 430 via video to server output 342 of second resolution module 326. Video to server output 342 may initially carry identifying information to support the generation of a server URL. For example, if a user named “Bob” with a login name of “bobisbest” is initially shooting footage of a peculiar animal on cell phone 350, Bob may optionally enter a title for the video in step 502 on cell phone 350, such as “Puppy or chicken?”. Alternatively, Bob might not enter a title, and a default title (e.g., a sequential number) may be automatically assigned. A server URL may be generated in step 508 to support subsequent access to the video from a server (e.g., server 430). After cell phone 350 finishes shooting the video in step 514 (via the actuation of a “stop” or “end of shoot” button or the like received on/at cell phone 350), the control logic of cell phone 350 may prompt or otherwise enable Bob to edit the video in optional step 520. The editing may take place automatically, via user selected preferences/options, or via a manual editing process. Alternatively, cell phone 350 might not be configured to enable any editing. Cell phone 350 may optionally prompt Bob in step 526 as to whether he wants to upload the video entitled “Puppy or chicken?” to a server (via video to server output 342). Alternatively, cell phone 350 might not prompt Bob as to whether he wants to upload the video; instead, cell phone 350 may be configured to automatically upload the video at the conclusion of the shoot (e.g., step 514) and/or editing of the footage (e.g., step 520). Assuming that cell phone 350 is configured to generate a prompt as in step 526, Bob may confirm his interest to upload the video in step 532 (via the actuation of an “upload video” button or the like on/at cell phone 350), at which point the video may be uploaded to a server in step 538. Furthermore, once the video is uploaded to the server, cell phone 350 may optionally be configured to remove/delete the video, the torrent file URL, torrent files and any other information related to the video from cell phone 350 in step 544 in order to preserve computing resources on cell phone 350. Alternatively, the video, the torrent file URL, the torrent files and other information related to the video may remain on cell phone 350 until either Bob provides an indication that he desires to delete the referenced material from cell phone 350, or after a predetermined time period has expired. If Bob elected not to upload the video to the server responsive to the generated prompt in step 526, cell phone 350 may enable Bob to upload the video at a later time (not shown). For example, Bob might not want to take the time immediately after shooting the “Puppy or chicken?” video to undertake a manual editing process that he feels is important prior to posting it to a server; thus, Bob may defer editing and/or uploading the video until he has had an opportunity to review it on cell phone 350 and has recast various scenes from the footage. The various steps illustrated in FIG. 5 may be modified or rearranged without departing from the scope of the demonstrated method. For example, steps 502 and 508 (receiving a title of the video and generating a server URL, respectively) may take place after the end of video shoot has been received in step 514. Other modifications are possible.

After video has been uploaded to one or more servers (e.g., server 430), a user of personal computer 420 may be able to retrieve (e.g., download) the video footage 452 from server 430 (via 452a) using a search query based on at least some of the identifying information. Alternatively, or additionally, the video footage 452 may be acquired by handheld device 410 (via 452b), or any other video camera, video capture device, and the like. Moreover, the server may provide additional classifying information to enable searching on a broader basis. For example, a user may enter a search query related to “animals”. Responsive to the entered search query, a number of videos may be returned including the video “Puppy or chicken?” as shot by Bob. The server may be a commercial server that typically hosts video files of this nature (e.g., YouTube). Alternatively, the server may be a personal web server belonging to Bob, allowing Bob greater flexibility with respect to controlling access to the video files he uploads. For example, Bob may impose additional security in the form of a password or the like in order for a user to gain access to Bob's files. The password may be included with the identifying information sent in the initial live broadcast. Alternatively, the password may be sent at the conclusion of the initial live transmission, and only to a select number of users; thus, some users may only have the option of viewing the live broadcast while not being granted access to files on Bob's personal server.

A receiving device may be configured to attempt to access the video footage from various entities in a particular order. For example, assume handheld device 410 initially received a live broadcast of the “Puppy or chicken?” video as shot by Bob on May 1, 2007. Handheld device 410 may thereafter maintain in a listing a record of the “Puppy or chicken?” video as having been viewed/accessed along with corresponding identifying information. On May 15, 2007, Bob may upload the video “Puppy or chicken?” from cell phone 350 to a commercial server and/or his personal server after having edited the video to remove a particular scene. In the process of uploading, cell phone 350 may remove/delete the video, torrent file URL, and any torrent files from cell phone 350. Thereafter, on Jun. 1, 2007, a user of handheld device 410 may want to watch the “Puppy or chicken?” video again after having reviewed a listing of videos that were accessed on handheld device 410 within the past two months. In response to a request to obtain the video, handheld device 410 may be configured to first attempt to retrieve the video via one or more torrent files. The BitTorrent retrieval attempt will fail, however, given that the torrent file URL and torrent files have been deleted. Next, handheld device may be configured to attempt to retrieve the “Puppy or chicken?” video from the commercial server based on at least some of identifying information as discussed previously. If Bob has not removed the “Puppy or chicken?” video from the commercial server between May 15, 2007, and Jun. 1, 2007, then the video retrieval from the commercial server will be successful. Conversely, if Bob removed the “Puppy or chicken?” video sometime in between (e.g., Bob removed the “Puppy or chicken?” video from the commercial server on May 23, 2007), then handheld device 410 will be unable to retrieve the “Puppy or chicken?” video from the commercial server. Under this scenario, handheld device 410 may be configured to attempt to retrieve the “Puppy or chicken?” video from Bob's personal server. Assuming that Bob has not removed the “Puppy or chicken?” video from his personal server, the retrieval will be successful; otherwise, handheld device 410 may generate a warning message indicating that the retrieval was not successful due to the video no longer being available. Alternatively, if handheld device 410 is not aware of Bob's personal server, a web browser may be launched on handheld device 410 and a search engine (e.g., Google) may be accessed with a search query automatically generated based on at least some of the identifying information discussed previously. The search engine may return the “Puppy or chicken?” video as a search result responsive to the search query. Initially, handheld device 410 (or any other receiving device) may be configured to engage in a polling process or a similar automatic mechanism to determine whether the video “Puppy or chicken?” is posted to a server based on a timestamp, watermark, the identifying information, or the like, thus allowing the video to be automatically retrieved without requiring a user to manually search for or determine whether the video has been uploaded to the server.

In at least one embodiment, the source device (e.g., cell phone 350) may prompt Bob at the time of the video shoot as to whether he intends to upload the video to one or more servers. If Bob indicates an intention not to upload the video to one or more servers, information to that effect may be included as part of the initial live distribution of the video “Puppy or chicken?”, and all information related to the video may be removed from cell phone 350 after a predetermined time period. Thus, if Bob indicates that he does not intend to upload the video, (a user of) receiving handheld device 410 will know to act quickly to retrieve the video via BitTorrent or the like before the video is potentially no longer available. Alternatively, even if Bob indicates that he does not intend to upload the video, cell phone 350 may be configured to retain the video and all the information related to the video on cell phone 350 until Bob decides to manually delete it, thereby allowing Bob to change his mind.

Various services may be established to support both the upload and retrieval processes associated with the video footage. A central service provided by a commercial server or the like may facilitate finding both live streaming and stored videos. Using metadata (e.g., the identifying information), it may be possible to “subscribe” to the stored video file while watching the live streaming video. There may be a mechanism wherein a login name of the author of the video (e.g., “bobisbest”) may be used to locate the user's World Wide Web (WWW) homepage, which may in turn provide further information including a cellphone number or the like, which may enable locating/retrieving videos attributed to the user. Some or all of these mechanisms may be incorporated as a part of a separate peer-to-peer portal or the like.

Other resolution schemes may be possible. The examples contained herein have primarily demonstrated using two resolutions (e.g., first resolution module 308 and second resolution module 326). Alternative embodiments may include additional resolutions (e.g., third resolution module, fourth resolution module, etc.) Still further, the architectures as shown in the various figures are merely illustrative. Other arrangements may be included without departing from the scope of the present invention. For example, first resolution module 308 may be integrated with camera 302. Other modifications will be appreciated by those of skill in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a camera;
a processor; and
a memory having stored therein computer readable instructions that, when executed by the processor, cause the apparatus to perform:
shooting a video footage;
distributing the video footage live at a first resolution;
saving the video footage at a second resolution; and
distributing the saved video footage.

2. The apparatus of claim 1, wherein the first resolution is of a different quality than the second resolution.

3. The apparatus of claim 2, wherein the first resolution is of a lower quality than the second resolution.

4. The apparatus of claim 1, wherein the computer readable instructions further include at least one instruction that, when executed, causes the apparatus to perform:
transmitting identifying information identifying the video footage.

5. The apparatus of claim 1, wherein the computer readable instructions further include at least one instruction that, when executed, causes the apparatus to perform:
transmitting identifying information identifying the apparatus as the source of the video footage.

6. The apparatus of claim 1, wherein the computer readable instructions further include at least one instruction that, when executed, causes the apparatus to perform:
transmitting a URL, wherein the URL includes information identifying the video footage that enables a receiving device to retrieve the video.

7. The apparatus of claim 1, wherein the computer readable instructions further include at least one instruction that, when executed, causes the apparatus to perform:
transmitting identifying information identifying the video footage periodically.

8. The apparatus of claim 1, wherein the computer readable instructions further include at least one instruction that, when executed, causes the apparatus to perform:
receiving a request to redistribute the video footage; and
responsive to the request, distributing the saved video footage.

9. The apparatus of claim 1, wherein the first resolution is determined based on the display capabilities of an intended destination of the distribution.

10. The apparatus of claim 1, wherein the computer readable instructions further include at least one instruction that, when executed, causes the apparatus to perform:
uploading the saved video footage to a server, wherein the video footage is accessible from the server based on identifying information included in the live distribution.

11. The apparatus of claim 10, wherein after the saved video footage is uploaded to the server, the apparatus deletes information related to the video footage saved on the apparatus.

12. A method comprising:
shooting a video footage;
distributing the video footage live at a first resolution;
saving the video footage at a second resolution; and
distributing the saved video footage.

13. The method of claim 12, wherein the method further comprises:
determining identifying information corresponding to the video footage, wherein the identifying information includes at least one of: author identity, source device address, and file identity.

14. The method of claim 12, wherein the first resolution is based on the display capabilities of an intended destination device of the video footage.

15. The method of claim 12, wherein the method further comprises:
uploading the saved video footage to a server.

16. The method of claim 12, wherein the saved video footage is edited and subsequently saved.

17. The method of claim 12, wherein a file is created and periodically updated concurrent with the shooting the video footage.

18. A system comprising:
a network of peer-to-peer devices, wherein a first device shoots a video footage and distributes the video footage live while simultaneously saving the video footage, and wherein a second device, responsive to receiving the video footage, requests a redistribution of the video, and wherein, responsive to the request, a third device supplies at least a portion of the retransmitted video.

19. The system of claim 18, wherein the live distribution further includes a telephone number of the first device as metadata, wherein the telephone number is used by the second device to place a cellular data call to facilitate the requesting of the redistribution of the video.

20. The system of claim 18, wherein each device maintains a listing of videos accessed, wherein each listing includes identifying information corresponding to each video accessed.

21. The apparatus of claim 7, wherein the identifying information comprises a torrent file URL.

22. A method comprising:
shooting a video footage;
recording the video footage in at least two different resolutions; and
storing the video footage in one of the at least two different resolutions.

23. The method of claim 22, further comprising:
playing on a display device the stored video footage responsive to a request received via a user interface;
receiving user input via the user interface selecting the video footage;
receiving user input via the user interface identifying a selected resolution of the video footage; and
responsive to the receiving, transmitting the selected video footage in the selected resolution to a server.

24. One or more computer readable media storing computer executable instructions that, when executed, perform video distribution, comprising:
shooting a video footage;
distributing the video footage live at a first resolution;
saving the video footage at a second resolution; and
distributing the saved video footage.

25. The one or more computer readable media of claim 24, wherein the computer executable instructions further include at least one instruction that, when executed, performs:
determining identifying information corresponding to the video footage; and
distributing the identifying information with the video footage live at the first resolution.

26. The one or more computer readable media of claim 24, wherein the computer executable instructions further include at least one instruction that, when executed, performs:
receiving a request to redistribute the video footage; and
responsive to the request, distributing the saved video footage at the second resolution.
